(19) United States
(12) Patent Application Publication
(10) Pub. No.: US 2007/0120818 A1
(43) Pub. Date: May 31, 2007

(54) Method for selecting input end of display

(76) Inventor: Young Kai Li, Taipei (TW)

Correspondence Address: Young Kai Li, 235 Chung - Ho, Box 8-24, Taipei, TW

(21) Appl. No.: 11/287,097

(22) Filed: Nov. 28, 2005

(51) Int. Cl. G09G 5/00

(52) U.S. Cl. 345/156

(57) ABSTRACT

A method for selecting an input end of a display so that the display can display the signals from a selected input end wherein the user can select switching functions automatically or manually. Furthermore, if a manual switching mode being selected, selecting an input end to be displayed; and if the automatic switching mode is selected, the system processes according to predetermined searching sequence which is then displayed on the display. Moreover if no selection is performed, the system entering into an automatic switching mode. The input signals are one of analog signals and digital signals. The input end has a specification selected from one of DVI, D-SUB, VIDEO and S-VIDEO. Besides, the display is installed with a hot key for selecting the menu by keying the hot key to the auto-switching mode or a menu-switching mode.

### FIELD OF THE INVENTION

The present invention relates to displays, and in particular to a method for selecting an input end of a display so that the display can display the signals from a selected input end. In the present invention, the user can select switching functions automatically or manually.

### BACKGROUND OF THE INVENTION

Current displays have a plurality of image input ends, such as DVI, D-SUB, VIDEO, S-VIDEO, etc. Of course, displays can accept the signals of different specifications. However how to switch a display to a desired input specification is an important problem.

Currently, menu switching is used. Namely, the display will record the previous setting. When the display is actuated next time, the display receives the signals from the previous signal input end and displays the signals without determining whether signals are inputted to the previous signal input end. Therefore when the display has at least two signal input ends or different signal input ends are connected to the display, the user must input the system menu for selection a desired signal input end. The operation is inconvenient.

Besides an auto-switching display is designed. Each time the display is actuated, the system searches all the signal input ends. If at least two input signals are searched, the system selects a signal input end according to a predetermined sequence. Therefore each time the display is actuated, it must be set again. The operation is inconvenient. Even there is only one input end has signals, the system will search all input ends so as to have a waiting time.

### SUMMARY OF THE INVENTION

Accordingly, the primary object of the present invention is to provide a method for selecting an input end of a display so that the display can display the signals from a selected input end wherein the user can select switching functions automatically or manually.

Furthermore, if a manual switching mode being selected, selecting an input end to be displayed; and if the automatic switching mode is selected, the system processes according to predetermined searching sequence which is then displayed on the display.

Moreover if no selection is performed, the system entering into an automatic switching mode.

In the present invention, the input signals are one of analog signals and digital signals. The input end has a specification selected from one of DVI, D-SUB, VIDEO and S-VIDEO.

Besides, the display is installed with a hot key for selecting the menu by keying the hot key to the auto-switching mode or a menu-switching mode.

### BRIEF DESCRIPTION OF THE DRAWINGS

FIG. 1 shows the flow diagram of the present invention.

FIG. 2 shows the structure of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

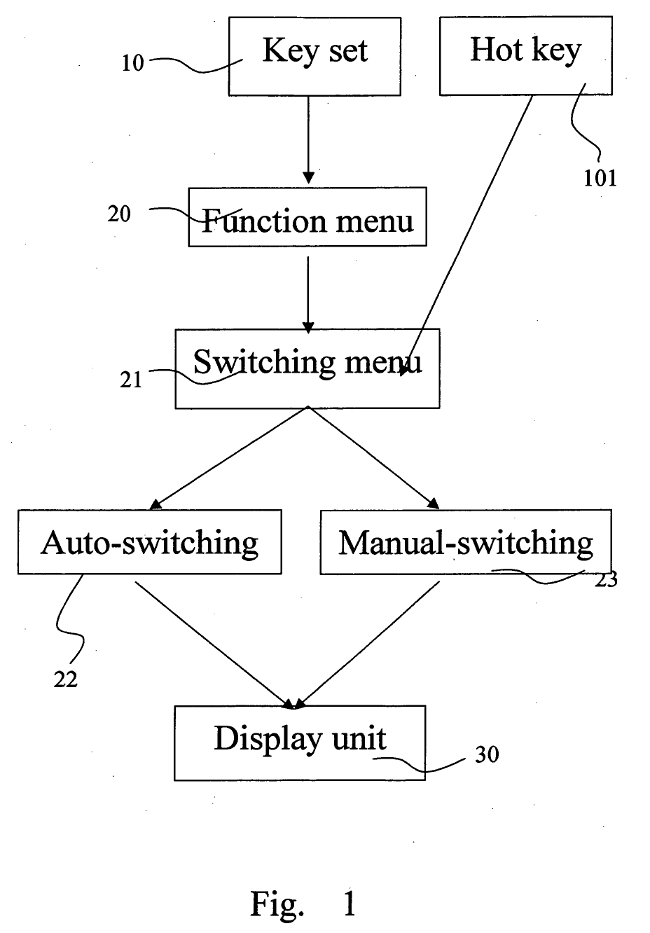

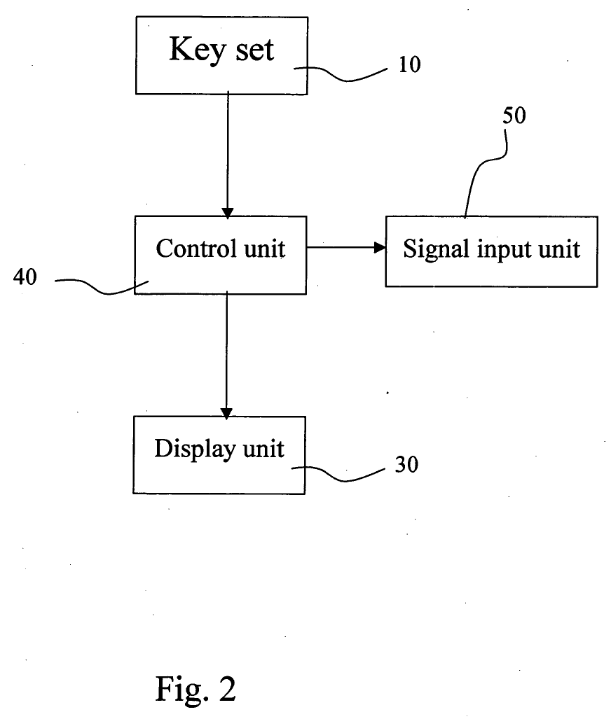

Referring to FIGS. 1 and 2, the process of the present invention is illustrated. The present invention comprises the following steps of: actuating a function menu 20 from a key set 22; then selecting switching automatically or manually; if no selection is performed, the system entering into an automatic switching mode 22; if a manual switching mode 23 is selected, selecting an input end to be displayed. The system switches the frame according to the selection state so that the signals are displayed on a display. If the automatic switching mode 22 is selected, the system processes according to predetermined searching sequence which is then displayed on the display.

The system has a key set 10, a display unit 30, a control unit 40 and a signal input unit 50. The key set 10 is connected to the control unit 40 for actuating the selection menu or input selection item (auto-switching mode 22 or manual switching mode 23). Then the control unit 40 performs the selection result. The signals received by the signal input unit 50 is displayed on the display unit 30.

If the switching way is not selected, the display unit is in the auto-switching mode. The control unit 40 will automatically search the signals in the signal input unit 50 according to a predetermined sequence in an internal program and then the signals are transferred to the display unit 30 to be displayed. Or the auto-switching mode 22 is actuated with the same sequence. Furthermore, if the manual switching mode 23 is selected, after switching, the user must select a signal input end to be displayed and then it is displayed by the display unit.

The key set 10 may be included with a hot key 101 for actuating the selection menu 21.

Moreover in the present invention, the input signals are one of analog signals and digital signals. The input end has a specification selected from one of DVI, D-SUB, VIDEO and S-VIDEO.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for selecting an input end of a display so that the display can display the signals from a selected input end; the method comprising the steps of:
actuating a menu of input ends;
selecting one of an automatic switching mode and a manual switching mode;
if a manual switching mode being selected, selecting an input end to be displayed; and
if the automatic switching mode is selected, the system searching an input end according to predetermined searching sequence; and the display displaying signals from a searched input end.

2. The method of claim 1, further comprising a step of: if no selection is performed, the system entering into an automatic switching mode;

3. The method of claim 1, wherein the input signals are one of analog signals and digital signals.

4. The method of claim 1, wherein the input end has a specification selected from one of DVI, D-SUB, VIDEO and S-VIDEO.

5. The method of claim 1, further comprising a step of after an input end being selected, the display unit switches its screen to match a selected frame.

6. The method of claim 1, wherein the display is installed with a hot key for selecting the menu by keying the hot key to the auto-switching mode or a menu-switching mode.
